(19) United States
(12) Patent Application Publication
(10) Pub. No.: US 2013/0277927 A1
(43) Pub. Date: Oct. 24, 2013

(54) Sand and Water Sled

(71) Applicant: Patricia Harvey, Norfolk, VA (US)

(72) Inventor: Patricia Harvey, Norfolk, VA (US)

(21) Appl. No.: 13/864,879

(22) Filed: Apr. 17, 2013

Related U.S. Application Data
(60) Provisional application No. 61/637,602, filed on Apr. 24, 2012.

(51) Int. Cl. B62B 15/00

(52) U.S. Cl. CPC B62B 15/007
USPC 280/19

(57) ABSTRACT

A sand and water sled includes a body member having opposed front and rear ends and a bottom extending between the front and rear ends, the body member having a rear wall extending upwardly from the bottom adjacent the rear end and opposed side walls extending upwardly from the bottom that extend between the rear wall and the front. The bottom includes an upper surface defines a container section adjacent the rear wall. A portable ice chest has a configuration removably received in the container section.

### REFERENCE TO RELATED APPLICATIONS

This invention claims the priority of U.S. Ser. No. 61/637,602 filed Apr. 24, 2012 entitled The Sand Sleigh.

### BACKGROUND OF THE INVENTION

This invention relates generally to a sled and, more particularly, to a sled constructed and configured to transport various objects over various types of terrain such as sand and water.

Planning a trip to the beach can be a logistical challenge. The car in which a person or group drove to the beach may be parked a significant distance from where the group is to be gathered on the sand. A typical beachgoer may bring chairs, coolers, bags, sports items, umbrella, canopy, radio, or other items that are heavy or awkward to carry. At any rate, these items are difficult to carry from the car to the beach in a single trip. The journey from the car to the beach when carrying multiple items is even more challenging if one or more young children must also be managed. Of course, multiple trips between the car and the beach may be made, this is tiresome. Then, after a day at the beach, the reverse procedure of collecting all items back to the car seems even more wearisome.

Therefore, it would be desirable to have a sled configured to receive all of a person's beach items and to slide easily upon the sand between a car and the beach. Further, it would be desirable to have a sled specifically configured to securely hold a portable ice chest for easy transport to the beach. In addition, it would be desirable to have a sled that is lightweight and buoyant so as to float on water.

### SUMMARY OF THE INVENTION

A sand and water sled according to the present invention includes a body member having opposed front and rear ends and a bottom extending between the front and rear ends, the body member having a rear wall extending upwardly from the bottom adjacent the rear end and opposed side walls extending upwardly from the bottom that extend between the rear wall and the front. The bottom includes an upper surface defines a container section adjacent the rear wall. A portable ice chest has a configuration removably received in the container section.

Therefore, a general object of this invention is to provide a sled that is configured and constructed to float on water and to efficiently slide on sand.

Another object of this invention is to provide a sled, as aforesaid, having a body member configured in the form of a boat so as to float on water yet having a lower surface that includes anti-friction characteristics when pulled on a sand surface.

Still another object of this invention is to provide a sled, as aforesaid, having a container section configured to selectively receiver a portable ice chest.

Yet another object of this invention is to provide a sled, as aforesaid, having a handle to lift the body member and a rope configured to pull the body member such as over a sand surface.

A further object of this invention is to provide a sled, as aforesaid, that is lightweight and buoyant.

A still further object of this invention is to provide a sled, as aforesaid, that is easy to use and inexpensive to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a sand and water sled according to a preferred embodiment of the present invention;

FIG. 2 is an exploded view of the sled as in FIG. 1;

FIG. 3 is a perspective view from a lower angle of the sled as in FIG. 1;

FIG. 4 is a perspective view of a sand and water sled according to another embodiment of the present invention;

FIG. 5 is an exploded view of the sled as in FIG. 4;

FIG. 6 is a perspective view of a portable ice chest removed from the sled body member as in FIG. 5; and

FIG. 7 is a perspective view of a sand and water sled according to another alternative embodiment of the present invention.

### DESCRIPTION OF THE PREFERRED EMBODIMENT

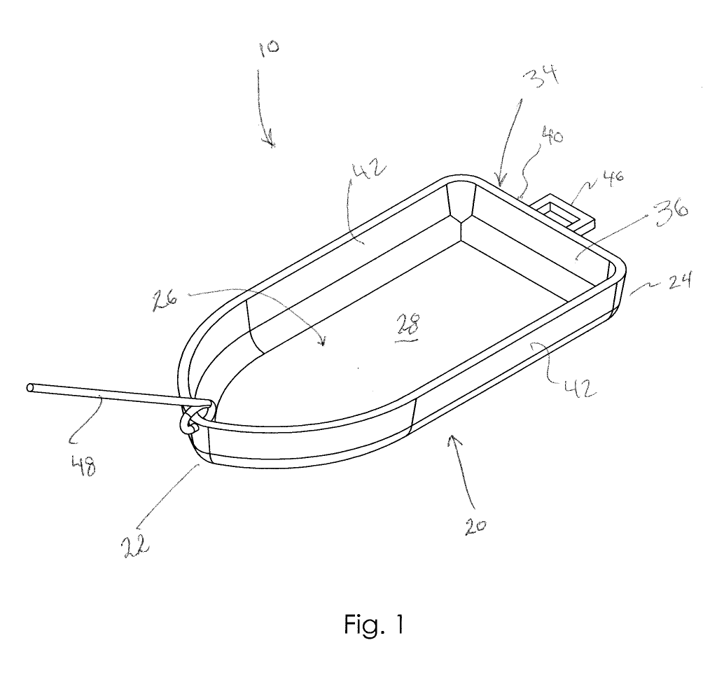

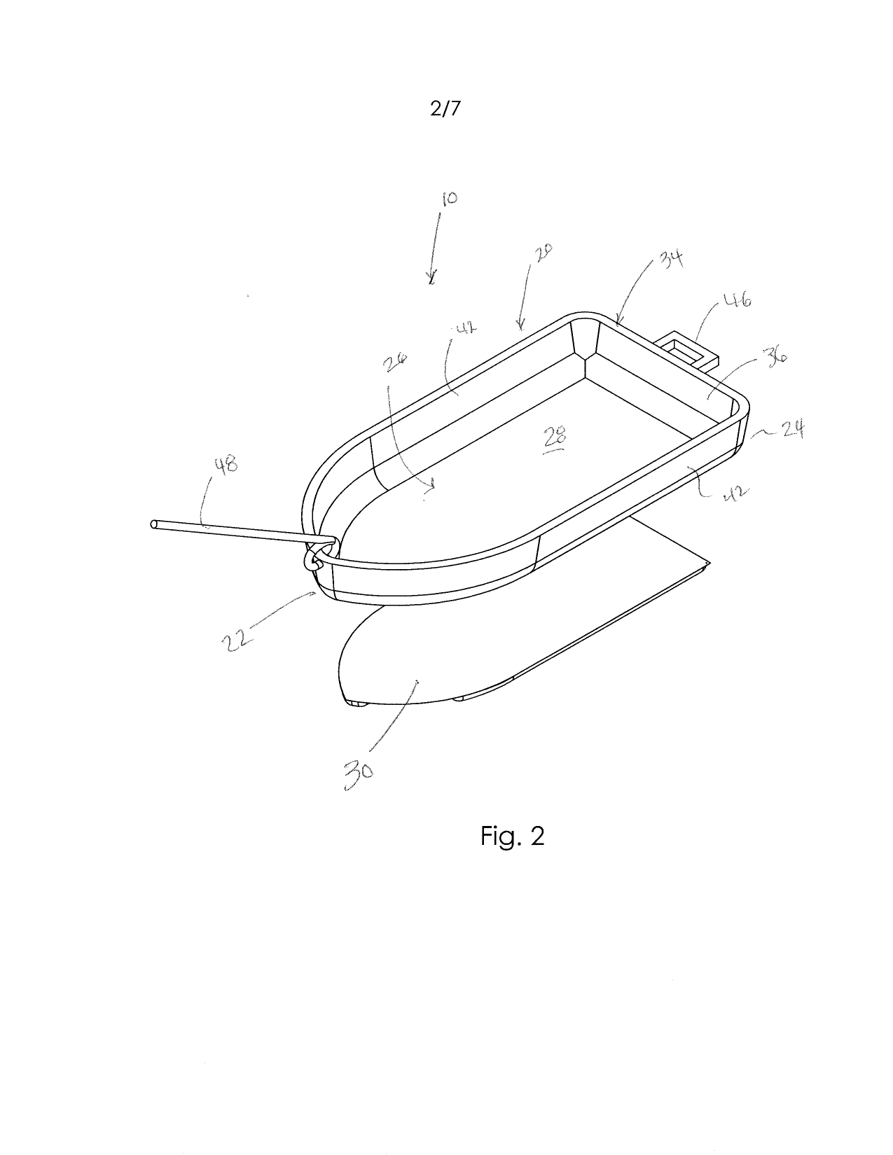

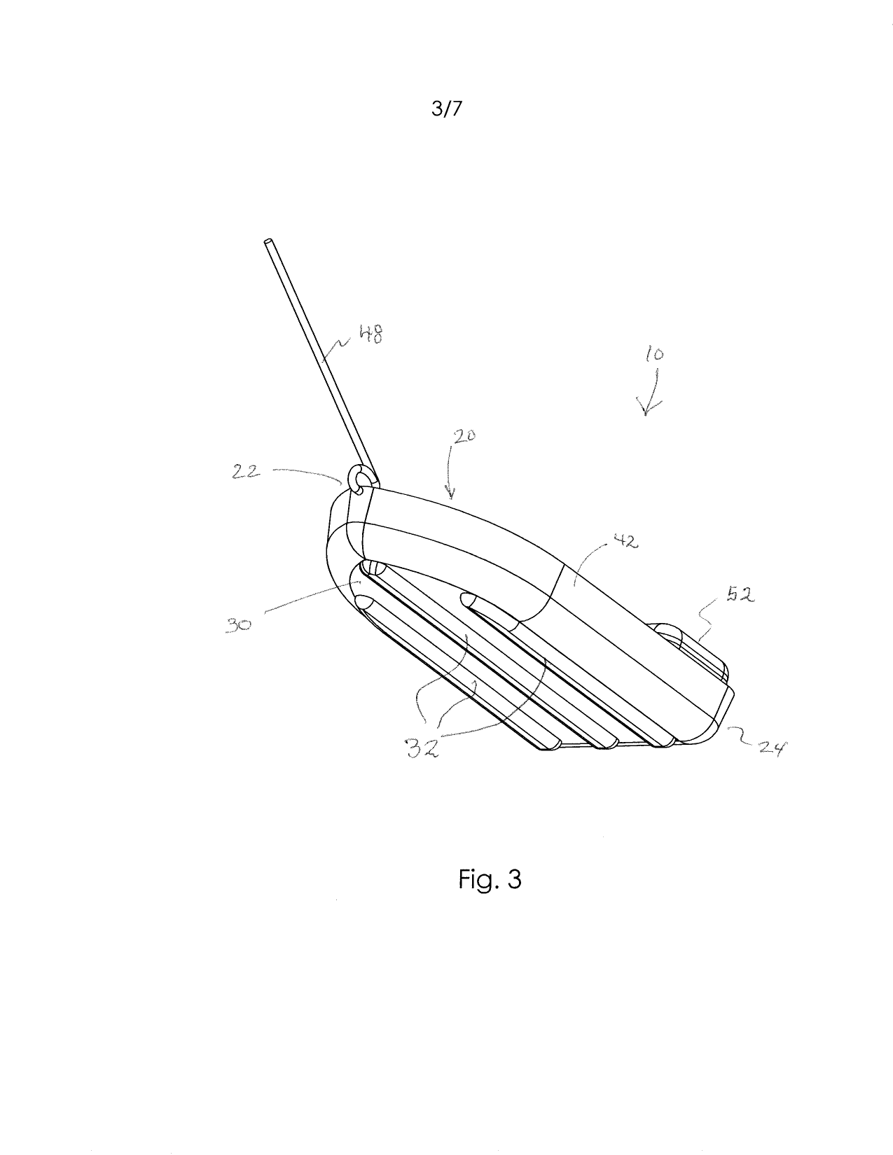

A sand and water sled according to embodiments of the present invention will now be described with reference to FIGS. 1 to 7 of the accompanying drawings.

The sand and water sled 10 according to one embodiment (FIG. 1) includes a body member 20 having opposed front 22 and rear 24 ends. The body member 20 includes a bottom 26 extending between the front 22 and rear 24 ends and having a generally planar or flat configuration. The bottom 26 includes an upper surface 28 and an opposed lower surface 30 that will be described in more detail below. A rear wall 34 extends upwardly from the bottom 26 adjacent the rear end 24 of the body member 20. Opposed side walls 42 extend upwardly from peripheral edges of the bottom 26 and extend between the rear wall 34 and the front end 22 of the body member 20. Preferably, the body member 20 is constructed of a lightweight material such as plastic.

The lower surface 30 of the bottom 26 of the body member 20 may be constructed of a material that inhibits or reduces friction. A suitable friction resistant material is Teflon®. Alternatively, the lower surface 30 of the bottom 26 may be coated with a friction reducing substance such as polytetrafluorethylene. The anti-friction characteristic of the lower surface 30 of the bottom 26 enables the body member 20 to be pulled more easily and with less resistance over a rough surface such as sand. The bottom 26, therefore, is able to glide across the sand or water with less effort by a user.

In another aspect, a plurality of elongate channels 32 are positioned in spaced apart relation upon the lower surface 30 of the bottom 26, the channels 32 extending substantially between the front 22 and rear 24 ends of the bottom 26. The channels 32 may enhance the efficiency of sliding on a sand surface but may also prevent damage to the bottom 26 when the body member 20 is pulled over rough surfaces such as a cement, gravel, or blacktop street or parking lot surfaces.

The sand and water sled 10 may include a handle 46 coupled to the exterior surface of the rear wall 34. Although the handle 46 is shown in the drawings as having a generally rectangular configuration, it is understood that a T-shaped, circular, or other shape may also be suitable. The handle 46 enables a user to lift the body member 20 more efficiently, such as when placing the body member 20 into the water, removing it therefrom, or lifting it to/from an automobile for transport.

The sand and water sled 10 may include a rope 48 or cable coupled to the front end 22 of the body member 20. Preferably, the rope 48 is coupled to an apex or point where the side walls 42 of the body member 20 slope toward one another and are connected together (FIG. 1). The rope 48, of course, has a flexible configuration and enables a user to grasp it to pull the sled 10 over sand, water, snow, or even a hard surface such as a parking lot.

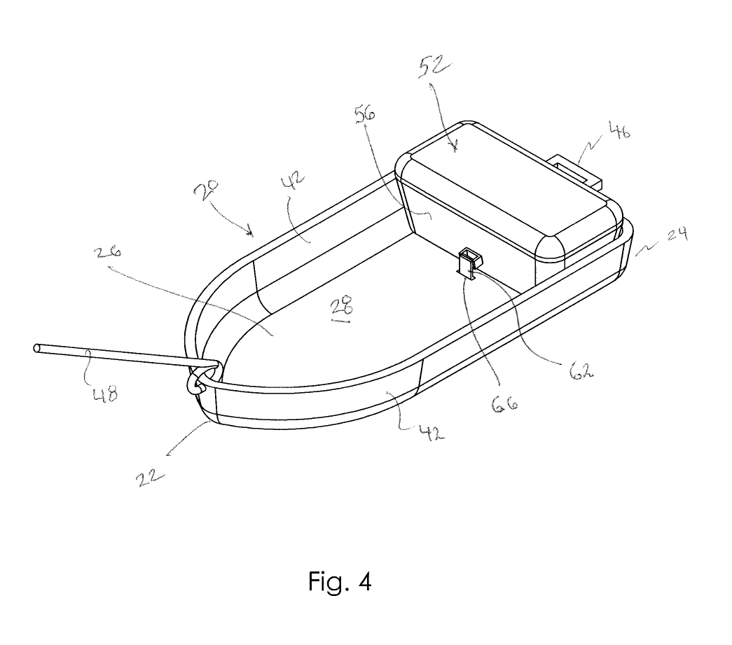

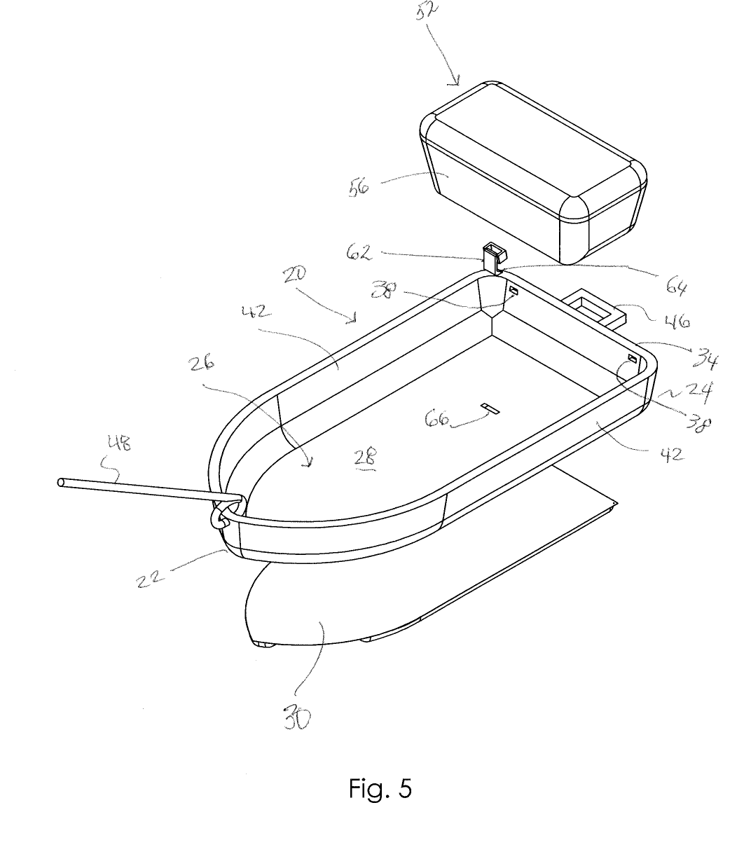

The upper surface 28 of the bottom 26 of the body member 20 defines a container section 50 inwardly adjacent the rear wall 34. The container section 50 has a configuration and dimensions for selectively receiving a container such as a portable ice chest 52 in one embodiment (FIG. 4). The ice chest 52 is selectively removable from the container section 50 (FIG. 5). As shown in FIG. 5, unique structures are included to selectively hold the ice chest 52 in the container section 50, i.e. to prevent the ice chest 52 from sliding around within the interior space defined by the rear wall 34, side walls 42, and bottom 26 of the body member 20.

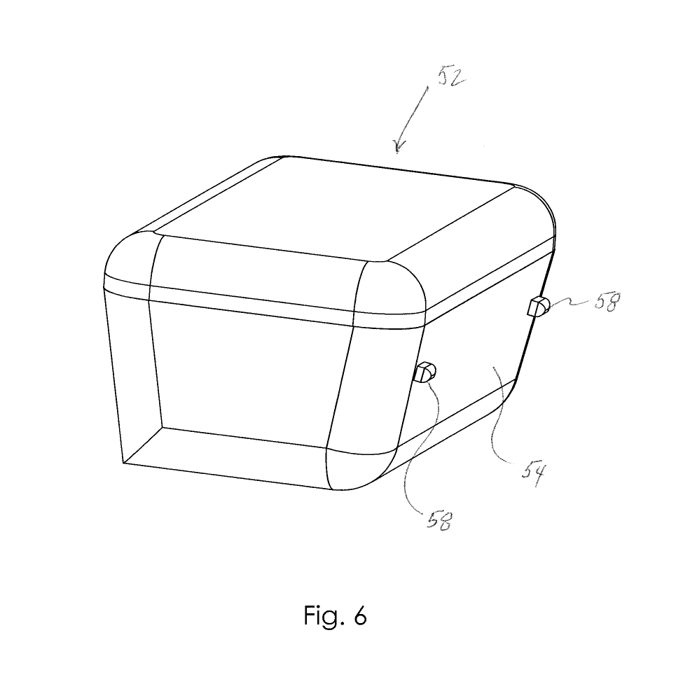

More particularly, a rear surface 54 of the ice chest 52 includes at least one protrusion 58 (but preferably a pair of protrusions) extending rearwardly away therefrom (FIG. 6). The rear wall 34 includes an interior surface 36 defining at least one recess 38 (but preferably a pair of recesses) configured to selectively receive a corresponding protrusion 58 when the ice chest 52 is positioned in the container section 50, the protrusion having a configuration that is complementary to the corresponding recess 38.

Further, the ice chest 52 includes a front wall 56 and a strap 62 coupled thereto, the strap 62 having a flexible configuration and having a strap fastener 64 at a free end thereof. The strap fastener 64 may be a latch, buckle, snap, hook and loop fastener, or the like. It is understood that the strap/strap fastener may include singular construction as a latch or the like. The upper surface 28 of the bottom 26 of the body member 20 may include a locking member 66 configured to selectively engage the strap fastener 64. It is understood that the locking member 66 may be a fastener combination complementary to the strap fastener 64. For example, the locking member 66 may be a mating buckle, a mating snap fastener, a loop fastener configured to engage a hook fastener, or the like.

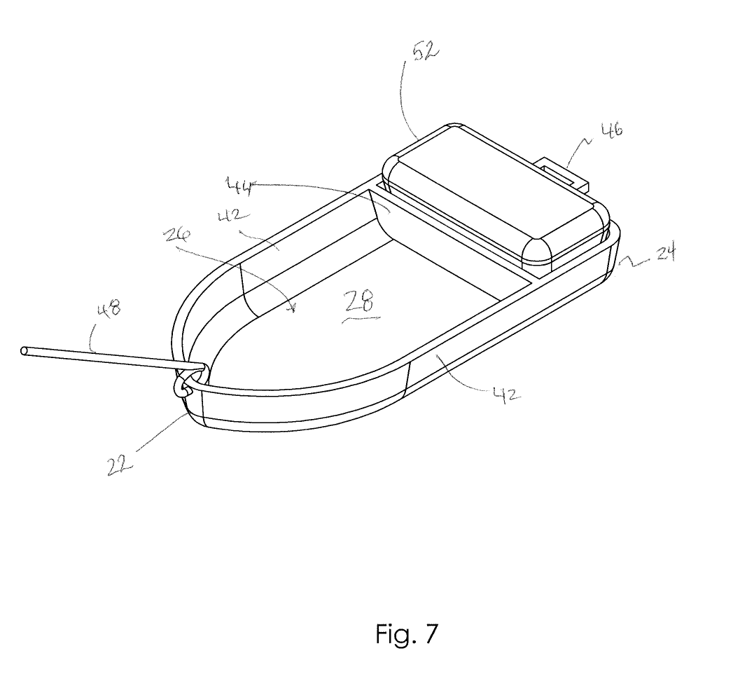

In one embodiment, the body member 20 includes an auxiliary rear wall 44 that extends upwardly from the bottom 26 and is forwardly displaced from the rear wall 34. The auxiliary rear wall 44 is parallel to the rear wall 34 and, together, the walls form an interior area configured to securely receive an ice chest 52. Specifically, an ice chest 52 may be inserted into the space between the upstanding walls or removed therefrom. The ice chest 52, therefore, is prevented from sliding around upon the bottom 26 of the body member 20 even without operation of strap fastener 64 or protrusion/recess combination as described above. As shown in FIG. 7, the auxiliary rear wall 44 may be molded in as part of the body member 20, i.e. integrally constructed. In one embodiment (not shown), the auxiliary rear wall 44 may be slidably adjustable to vary the dimensions of the space between the upstanding walls so as to accommodate ice chests of different sizes.

In use, the interior area of the sled 10 may be loaded with various articles such as a cooler, umbrella, chairs, towels, and the like such that all of the items needed at the beach may be transported between an automobile and the beach in one trip. In fact, the sled 10 may be loaded even before leaving home and may be left loaded in the automobile between outings to the beach. The loaded sled 10 may then be pulled along the ground and sand en route to a selected location on the beach, the lower surface 30 of the bottom 26 of the body member 20 resisting friction that would otherwise cause an undesirable heat issue or other damage to the body member 20.

Once unloaded at the beach, the sled 10 may be placed on the water and used in the manner of a small boat or raft. In an embodiment too small to accommodate people, the sled 10 may still be used to carry an ice chest 52 and other items onto the water in close proximity to be accessed by a user. For instance, a user may wish to store cold beverages in the ice chest 52 for easy access while playing in the water.

It is understood that while certain forms of this invention have been illustrated and described, it is not limited thereto except insofar as such limitations are included in the following claims and allowable functional equivalents thereof.

1. A sand and water sled, comprising:
a body member having opposed front and rear ends and a bottom extending between said front and rear ends, said body member having a rear wall extending upwardly from said bottom adjacent said rear end and opposed side walls extending upwardly from said bottom that extend between said rear wall and said front;
wherein said bottom includes an upper surface defining a container section adjacent said rear wall; and
a portable ice chest having a configuration removably received in said container section.

2. The sand and water sled as in claim 1, wherein:
said ice chest includes a rear surface having at least one protrusion extending away from said rear surface; and
said rear wall of said body member includes an interior surface defining at least one recess configured to selectively receive said at least one protrusion of said ice chest when said ice chest is positioned at said container section.

3. The sand and water sled as in claim 2, wherein:
said ice chest includes a front wall and a strap coupled thereto, said strap having a flexible configuration with a strap fastener at a free end thereof; and
said upper surface of said bottom includes a locking member configured to selectively engage said strap fastener.

4. The sand and water sled as in claim 2, wherein said body member includes an auxiliary rear wall extending upwardly from said bottom and forwardly displaced from said rear wall such that said ice chest is removably positioned between said rear wall and said auxiliary rear wall.

5. The sand and water sled as in claim 2, wherein said bottom includes a lower surface constructed of a material which inhibits friction when said bottom is moved across sand.

6. The sand and water sled as in claim 5, wherein said lower surface of said bottom is coated with polytetrafluorethylene.

7. The sand and water sled as in claim 5, wherein said lower surface of said bottom is constructed of Teflon®.

8. The sand and water sled as in claim 2, wherein said lower surface of said bottom includes a plurality of elongate channels extending substantially between said front and said rear ends of said body member, said channels being configured to enhance sliding of said body member over a sand surface.

9. The sand and water sled as in claim 1, further comprising a handle coupled to an exterior surface of said rear wall, said handle being configured to be selectively grasped by a user.

10. The sand and water sled as in claim 1, further comprising a rope coupled to said front of said body member, said rope having a flexible configuration to be selectively pulled by a user.

11. The sand and water sled as in claim 1, wherein said body member includes a front portion in which said side walls are curved inwardly and are connected at an apex of said front of said body member.

12. The sand and water sled as in claim 1, wherein said body member is waterproof.

13. The sand and water sled as in claim 12, wherein said body member is constructed of a lightweight material that floats on water.
